(19) United States
(12) Patent Application Publication
(10) Pub. No.: US 2004/0131382 A1
(43) Pub. Date: Jul. 8, 2004

(54) Method of reproducing process cartridge or developing apparatus

(75) Inventors: Ken Kikuchi, Shizuoka (JP); Toru Oguma, Shizuoka (JP); Akiyoshi Yokoi, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/670,246

(22) Filed: Sep. 26, 2003

(30) Foreign Application Priority Data
Sep. 30, 2002 (JP) 2002-287307(PAT.)
Sep. 16, 2003 (JP) 2003-323555(PAT.)

(51) Int. Cl. G03G 15/00

(52) U.S. Cl. 399/109

(57) ABSTRACT

A method of reproducing a process cartridge or a developing apparatus has the step of removing a supporting member from a developing frame body, the step of separating a developer container and the developing frame body from each other in a joint portion wherein the developer container and the developing frame body are joined together, the sticking step of sticking a seal member for closing an opening portion for supplying a developer in the separated developer container, the developer refilling step of refilling the developer container with the developer, the step of recoupling the developer container and the developing frame body together thereafter, and the step of reattaching the supporting member onto one of the developer container and the developing frame body. Thereby, the reproduction of the developing apparatus or the process cartridge can be effected easily.

### BACKGROUND OF THE INVENTION

1. Field of the Invention

This invention relates to a method of reproducing a process cartridge detachably attachable to an electrophotographic image forming apparatus and a method of reproducing a developing apparatus.

2. Description of Related Art

In an image forming apparatus using an electrophotographic image forming process, there has heretofore been adopted a cartridge system in which developing means and a developer containing portion are integrally made into a cartridge or an electrophotographic photosensitive member and process means (including the developing means and the developer containing portion) for acting on the electrophotographic photosensitive member are integrally made into a cartridge, which is made detachably attachable to an electrophotographic image forming apparatus main body. The electrophotographic photosensitive member and the process means for acting on the electrophotographic photosensitive member which are integrally made into a cartridge are usually called a process cartridge.

According to this cartridge system, the maintenance of the image forming apparatus can be effected by a user himself without resort to a serviceman and therefore, operability can be markedly improved. So, this cartridge system is widely used in electrophotographic image forming apparatuses.

Such a cartridge (a developing apparatus made into a cartridge, or a process cartridge) serves to form an image on a recording medium by the use of a toner (developer). So, the toner is consumed as image forming is effected. The cartridge loses a commercial value as a cartridge when the toner has been consumed to such an extent that it becomes impossible to form an image of a quality satisfiable to a user who purchased the cartridge.

Heretofore there has been desired the realization of a simple cartridge reproducing method which can again commercialize a cartridge which has lost a commercial value with the toner therein consumed.

The present invention is applied to a method of reproducing a process cartridge made detachably attachable to an electrophotographic image forming apparatus and a method of reproducing a developing apparatus.

Here, the electrophotographic image forming apparatus is an apparatus for forming an image on a recording medium by the use of the electrophotographic image forming process. Examples of the electrophotographic image forming apparatus include an electrophotographic copying machine, electrophotographic printers (e.g. a laser printer, an LED printer, etc.), a facsimile apparatus, a word processor, etc.

Also, the process cartridge refers to at least developing means and an electrophotographic photosensitive member integrally made into a cartridge, which is made detachably attachable to an electrophotographic image forming apparatus main body.

### SUMMARY OF THE INVENTION

It is an object of the present invention to provide a method of reproducing a developing apparatus and a process cartridge which can be simply reproduced.

It is another object of the present invention to provide a method of reproducing a developing apparatus and a process cartridge which enable the attachment of a supporting member for supporting a developing member to be simply effected.

It is another object of the present invention to provide a method of reproducing a developing apparatus and a process cartridge which enable the mounting of a developing member to be effected simply and reliably.

It is another object of the present invention to provide a method of reproducing a developing apparatus and a process cartridge which enable a supporting member to be simply attached by a coupling member instead of the mounting portion of the supporting member removed when a developer container and a developing frame body are separated from each other, and a process cartridge.

It is another object of the present invention to provide a method of reproducing a developing apparatus detachably attachable to an electrophotographic image forming apparatus main body for developing a latent image formed on an electrophotographic photosensitive member, the developing apparatus having a developing member for developing the latent image formed on the electrophotographic photosensitive member, a developer container having a developer containing part containing therein a developer to be used by the developing member, and provided with a developer supplying opening for supplying the developer contained in the developer containing part to the developing member, a supporting member provided on a lengthwise end portion of the developing apparatus for supporting the developing member, and a developing frame body provided with a developer passing opening for passing therethrough the developer supplied from the developer supplying opening, and having a joint portion to be joined to the developer container, and a mounting portion for mounting the supporting member, the method having:

the supporting member removing step of removing the supporting member from the developing frame body;

the developing frame body separating step of separating the developer container and the developing frame body from each other in the joint portion, and at which at least a portion of the mounting portion is removed when the developer container and the developing frame body are separated from each other;

the sticking step of sticking a seal member for closing the developer supplying opening provided in the developer container separated at the developing frame body separating step;

the developer refilling step of refilling the developer containing part provided in the developer container separated at the developing frame body separating step with the developer;

the developing frame body coupling step of coupling the developer container and the developing frame body separated at the developing frame body separating step together after the sticking step; and

the supporting member attaching step of attaching the supporting member removed at the removing step onto at least one of the developer container and the developing frame body by the use of a coupling member.

It is another object of the present invention to provide a method of reproducing a process cartridge detachably attachable to an electrophotographic image forming apparatus main body, the process cartridge having a developing member for developing a latent image formed on an electrophotographic photosensitive member, the electrophotographic photosensitive member, a developer container having a developer containing part containing therein a developer to be used by the developing member, and provided with a developer supplying opening for supplying the developer contained in the developer containing part to the developing member, a supporting member provided on a lengthwise end portion of the process cartridge for supporting the developing member, and a developing frame body provided with a developer passing opening for passing therethrough the developer supplied from the developer supplying opening, and having a joint portion to be joined to the developer container, and a mounting portion for mounting the supporting member, the method having:

the supporting member removing step of removing the supporting member from the developing frame member;

the developing frame body separating step of separating the developer container and the developing frame body from each other in the joint portion, and at which at least a portion of the mounting portion is removed when the developer container and the developing frame body are separated from each other;

the sticking step of sticking a seal member for closing the developer supplying opening provided in the developer container separated at the developing frame body separating step;

the developer refilling step of refilling the developer containing part provided in the developer container separated at the developing frame body separating step with the developer;

the developing frame body coupling step of coupling the developer container and the developing frame body separated at the developing frame body separating step together after the sticking step; and

the supporting member attaching step of attaching the supporting member removed at the removing step onto at least one of the developer container and the developing frame body by the use of a coupling member after the developing frame body coupling step.

### BRIEF DESCRIPTION OF THE DRAWINGS

FIG. 1 is a typical cross-sectional view of an electrophotographic image forming apparatus according to an embodiment of the present invention.

FIG. 2 is a typical cross-sectional view of a process cartridge according to an embodiment of the present invention.

FIG. 3A is a side view of the process cartridge before a developing frame body separating step according to an embodiment of the present invention.

FIG. 3B is a side view of the process cartridge after the developing frame body separating step according to the embodiment of the present invention.

FIG. 4 is an exploded perspective view of the process cartridge according to the embodiment of the present invention.

FIG. 5 is an exploded perspective view of the process cartridge according to the embodiment of the present invention.

FIG. 6 is a side view of the process cartridge according to the embodiment of the present invention.

FIG. 7 is a perspective view showing a mounting portion for the process cartridge in the image forming apparatus according to the embodiment of the present invention.

FIG. 8 is an exploded perspective view of the process cartridge according to the embodiment of the present invention.

FIG. 9 is an illustration of the step of separating a developing frame body and a toner container from each other in a reproducing process for the process cartridge according to the embodiment of the present invention.

FIG. 10 is an illustration of the step of separating the developing frame body and the toner container from each other in the reproducing process for the process cartridge according to the embodiment of the present invention.

FIG. 11 is an illustration regarding the toner container in the reproducing process for the process cartridge according to the embodiment of the present invention.

FIG. 12 is an illustration regarding the developing frame body in the reproducing process for the process cartridge according to the embodiment of the present invention.

FIG. 13 is a perspective view of a seal member used in the reproducing process for the process cartridge according to the embodiment of the present invention.

FIG. 14 is an illustration regarding the developing frame body in the reproducing process for the process cartridge according to the embodiment of the present invention.

FIG. 15 is an illustration of the step of coupling the developing frame body and the toner container together in the reproducing process for the process cartridge according to the embodiment of the present invention.

FIG. 16 is an illustration regarding the coupling of a holder in the reproducing process for the process cartridge according to the embodiment of the present invention.

FIG. 17 is a side view of the inner side of the holder according to the embodiment of the present invention.

FIG. 18 is a front view of the developing frame body according to the embodiment of the present invention.

FIG. 19 is an illustration regarding the coupling of the developing frame body and the holder according to the embodiment of the present invention.

FIG. 20 is an illustration regarding the coupling of the developing frame body and the holder according to the embodiment of the present invention.

FIG. 21 is an illustration regarding the coupling of the toner container and the holder according to the embodiment of the present invention.

FIG. 22 is an illustration regarding the coupling of the developing frame body and the holder according to the embodiment of the present invention.

FIG. 23 is a typical view of a coupling member according to the embodiment of the present invention.

FIG. 24 is an illustration regarding the coupling of the developing frame body and the holder according to the embodiment of the present invention.

FIG. 25 is an illustration regarding the coupling of the developing frame body and the holder according to the embodiment of the present invention.

FIG. 26 is an illustration regarding the coupling of the toner container and the holder according to the embodiment of the present invention.

FIG. 27 is a perspective view showing the interior of the toner container according to the embodiment of the present invention.

FIG. 28 is a perspective view showing the interior of a cleaning container according to the embodiment of the present invention.

FIG. 29A is a side view of the process cartridge before the developing frame body separating step according to an embodiment of the present invention.

FIG. 29B is a side view of the process cartridge after the developing frame body separating step according to the embodiment of the present invention.

FIG. 30 is a flow chart showing a method of producing the process cartridge or the developing apparatus of the present invention.

### DESCRIPTION OF THE PREFERRED EMBODIMENTS

Some preferred embodiments of the present invention will hereinafter be described in detail by way of example with reference to the drawings. However, the dimensions, materials, shapes, relative disposition, etc. of constituent parts described in these embodiments are not intended to restrict the scope of the present invention thereto.

Description will hereinafter be made of an embodiment of the present invention regarding a method of reproducing a process cartridge. Here, the process cartridge includes developing means and a developer containing portion. Accordingly, an electrophotographic photosensitive member, etc. further added to a developing apparatus made into a cartridge can be said to be a process cartridge. Accordingly, the description of an embodiment of the present invention regarding the method of reproducing a process cartridge is also the description of an embodiment of the present invention regarding a method of reproducing a developing apparatus.

[Electrophotographic Image Forming Apparatus A and Process Cartridge B]

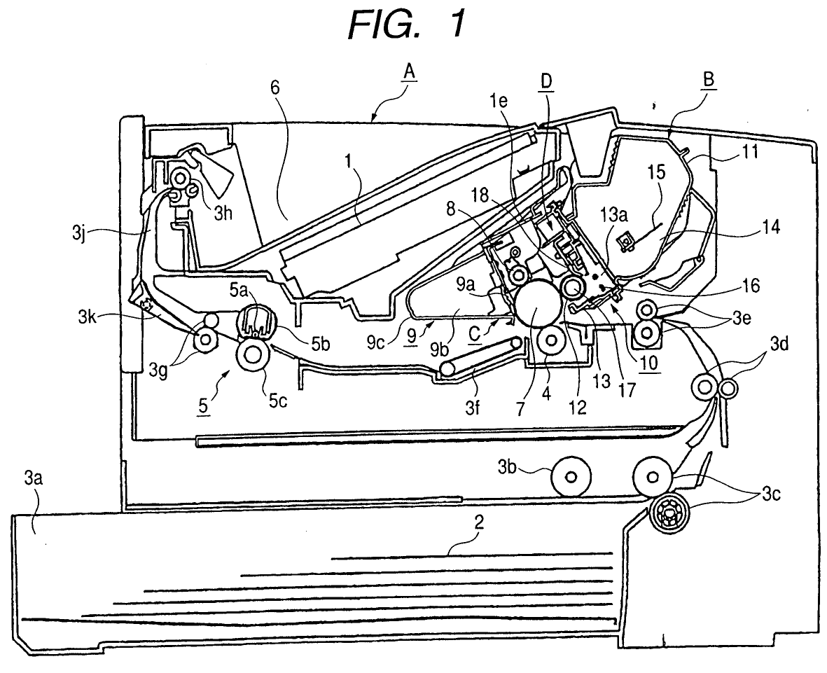

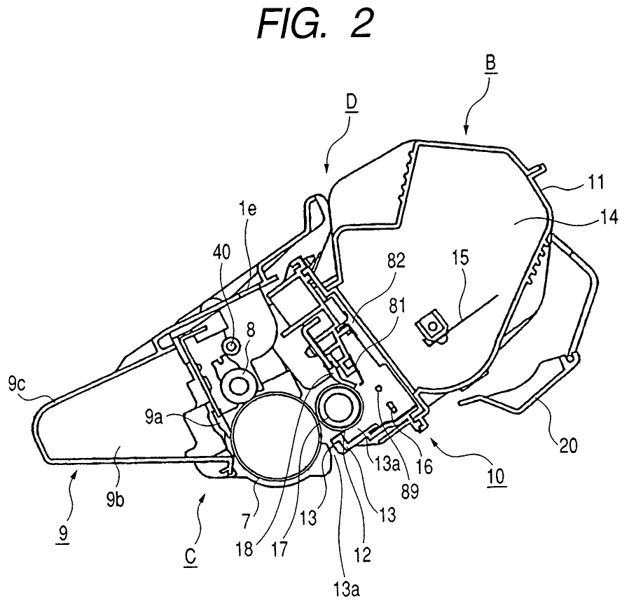

Reference is first had to FIGS. 1 and 2 in particular to describe an electrophotographic image forming apparatus according to an embodiment of the present invention. FIG. 1 is a typical cross-sectional view of the electrophotographic image forming apparatus according to the embodiment of the present invention. FIG. 2 is a typical cross-sectional view of a process cartridge according to an embodiment of the present invention.

The electrophotographic image forming apparatus A according to the present embodiment serves to form an image on a recording medium (such as recording paper, an OHP sheet or cloth) 2 by an electrophotographic image forming process.

The electrophotographic image forming process will be described here.

In this process, a toner image is formed on a drum-shaped electrophotographic photosensitive member (hereinafter referred to as the photosensitive drum). More particularly, charging is effected on the photosensitive drum 7 by charging means 8 to thereby uniformize the potential of the surface of the drum. Then, a laser beam conforming to image information is applied from optical means 1 to the photosensitive drum 7 to thereby form a latent image conforming to the image information on the photosensitive drum 7. This latent image is developed with a toner which is a developer by developing means 10 to thereby form a toner image.

On the other hand, in synchronism with the formation of this toner image, the recording medium 2 set on a sheet feeding cassette 3a is reverse-transported by a pickup roller 3b and pairs of transporting rollers 3c, 3d and 3e.

Then, the toner image formed on the photosensitive drum 7 in the process cartridge B is transferred to the recording medium 2 by a voltage being applied to a transferring roller 4 as transferring means. Thereafter, the recording medium 2 to which the toner image has been transferred is transported to fixing means 5 by a transport guide 3f. This fixing means 5 has a drive roller 5c and a fixing roller 5b containing a heater 5a therein. By this fixing means 5, heat and pressure are applied to the recording medium 2 passing therethrough to thereby fix the transferred toner image.

The recording medium 2 is then discharged to a discharging tray 6 via a reverse transport path 3j by the transporting forces of discharging rollers 3g and 3h. The discharging tray 6 is provided on the upper surface of the image forming apparatus A. A rockable flapper 3k can be operated to thereby discharge the recording medium 2 also without the intermediary of the reverse transport path 3j.

In the present embodiment, transporting means for transporting the sheet has the pickup roller 3b, the pairs of transporting rollers 3c, 3d, 3e, the transport guide 3f and the discharging rollers 3g, 3h.

The cartridge B will now be described with reference to FIGS. 1 and 2 in particular.

In the cartridge B, the photosensitive drum 7 is rotated and the surface thereof is uniformly charged by the application of a voltage to the charging roller 8 which is the charging means. Then, a laser beam conforming to the image information from the optical means 1 is applied to the photosensitive drum 7 through an exposure opening portion 1Q to thereby form a latent image. This latent image is developed by the developing means 10 by the use of the toner. The charging roller 8 is provided in contact with the photosensitive drum 7, and effects charging on the photosensitive drum 7. This charging roller 8 is driven to rotate by the photosensitive drum 7. Also, the developing means 10 supplies the toner to the developing area of the photosensitive drum 7 to thereby develop the latent image formed on the photosensitive drum 7.

In the developing means 10, the toner in a toner containing part 14 is fed out to a developing roller 12 by the rotation of a toner feeding member 15. A developing sleeve 12 as a developer carrying member containing a magnet 17 therein is then rotated. A toner layer having triboelectrification charges imparted thereto by a developing blade 18 is formed on the surface of the developing sleeve 12, and the toner is supplied to the developing area of the photosensitive drum 7. Then, the toner is shifted to the photosensitive drum 7 in conformity with the latent image to thereby form and visualize a toner image.

The developing blade 18 serves to prescribe the amount of toner on the peripheral surface of the developing sleeve 12 and also impart triboelectrification charges. Also, near this developing sleeve 12, there is rotatably mounted a toner agitating member 16 for circulating the toner in a developing chamber.

A voltage opposite in polarity to the toner image is then applied to the transferring roller 4, and the toner image formed on the photosensitive drum 7 is transferred to the recording medium 2. Thereafter, any residual toner on the photosensitive drum 7 is removed by cleaning means 9. The cleaning means 9 scrapes off the residual toner on the photosensitive drum 7 by an elastic cleaning blade 9a provided in abutting relationship with the photosensitive drum 7 and collects it into a waste toner reservoir 9b.

In the cartridge B, a toner container 11 having the toner containing portion 14 containing the toner therein and a developing frame body 13 for holding various constituent members including the developing sleeve 12 constituting the developing means 10 are coupled together. A cleaning frame body 9c having mounted thereon the photosensitive drum 7, the cleaning means 9 such as the blade 9a and the charging roller 8 is coupled to the developing frame member.

The cartridge B is made detachably attachable to the image forming apparatus A by an operator user.

Also, the cartridge B is provided with the exposure opening portion 1e for applying therethrough a light conforming to the image information to the photosensitive drum 7, and a transfer opening portion 13o for opposing the photosensitive drum 7 to the recording medium 2. More particularly, the exposure opening portion 1l is provided in the cleaning frame body 9c. The transfer opening portion 13o is provided between the developing frame body 13 and the cleaning frame member 9c.

Description will now be made of the construction of the housing of the cartridge B according to the present embodiment.

The cartridge B shown in the present embodiment has a housing constituted by the toner container 11 and the developing frame body 13 being coupled together, and the cleaning frame body 9c being pivotally coupled thereto. The photosensitive drum 7, the charging roller 8, the developing means 10 and the cleaning means 9 are contained in this housing and made into a cartridge. This cartridge B is detachably mounted with respect to cartridge mounting means provided in the image forming apparatus A and is used.

(Construction of the Housing of the Process Cartridge B)

The cartridge B according to the present embodiment is such that as previously described, the toner container 11, the developing frame body 13 and the cleaning frame body 9c are coupled together to thereby constitute a housing. This construction will hereinafter be described in detail.

As shown in FIG. 2, the toner feeding member 15 is pivotally mounted on the toner container 11.

Also, the developing sleeve 12 and the developing blade 18 are mounted on the developing frame body 13. Further, the agitating member 16 for circulating the toner in the developing chamber is rotatably mounted near the developing sleeve 12. Also, on the developing frame body 13, an antenna rod 89 is mounted in opposed relationship with the lengthwise direction of the developing sleeve 12 and substantially in parallelism to the developing sleeve 12.

The toner container 11 and the developing frame body 13 are welded together (ultrasonically welded together in the present embodiment) to thereby constitute an integral developing unit D.

A drum shutter member 20 for covering the photosensitive drum 7 to thereby protect it from being exposed to light for a long time or from contacting with foreign substances when the cartridge B has been detached from the image forming apparatus A is mounted on the developing unit D.

Also, as shown in FIG. 2, the photosensitive drum 7, the charging roller 8 and the various members of the cleaning means 9 are mounted on the cleaning frame member 9c to thereby constitute a unit C.

The developing unit D and the unit C are pivotally coupled together by a pin 40 to thereby constitute the cartridge B.

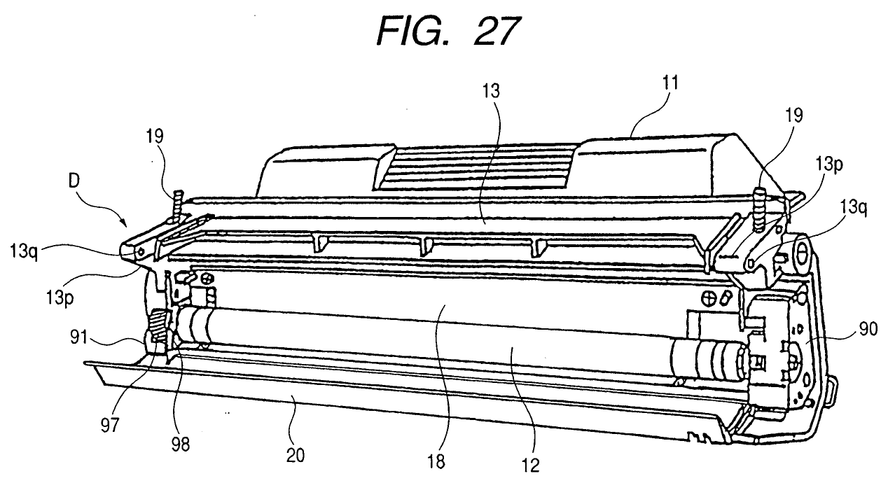

That is, as shown in FIG. 27, round pivot holes 13q are formed in the tip ends of arm portions 13p formed on the lengthwisely (axially of the developing sleeve 12) opposite sides of the developing frame body 13 in parallelism to the developing sleeve 12.

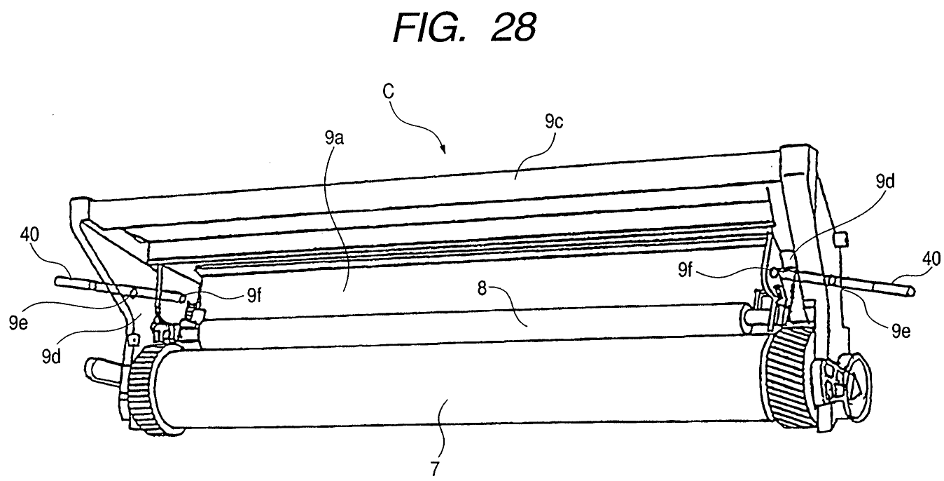

On the other hand, recesses 9d for receiving the arm portions 13p therein are formed at two locations in the lengthwisely opposite sides of the cleaning frame body 9c (see FIG. 28).

The pin 40 is forced into the mounting hole 9e of the cleaning frame body 9c with the arm portions 13p inserted in the recesses 9d. The pin 40 is then fitted into the pivot holes 13q at the ends of the arm portions 13p and is further forced into inner holes 9f to thereby mount the pin. Thereby, the developing unit D and the unit C are coupled together for pivotal movement about the pin 40.

At this time, compression coil springs 19 are inserted onto and mounted on dowels (not shown) provided upright on the roots of the arm portions 13p. The compression coil springs 19 abut against the upper walls of the recesses 9d of the cleaning frame body 9c. Thus, the developing frame body 13 is downwardly biased by the springs 19, whereby the developing sleeve 12 is reliably urged against the photosensitive drum 7.

(Holder L)

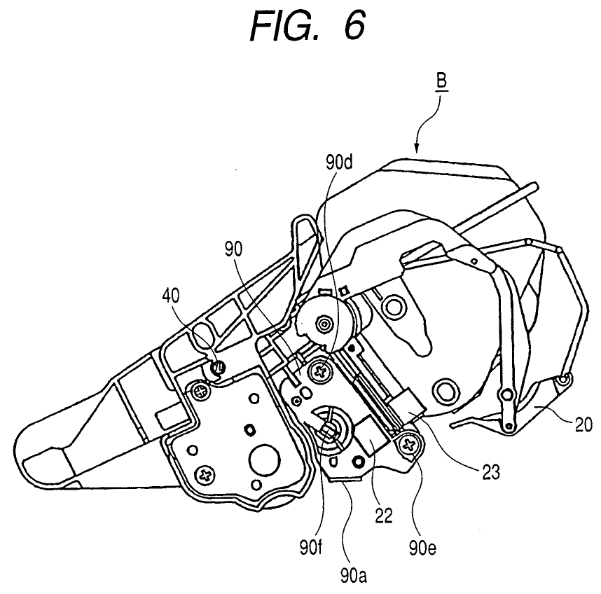

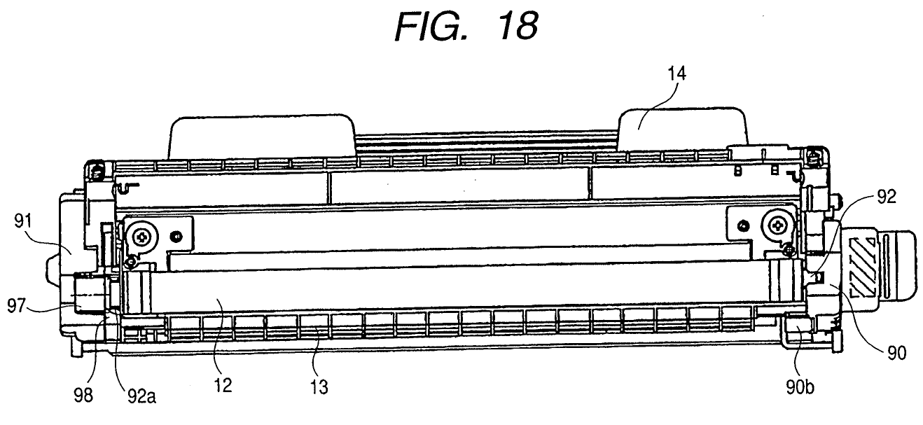

A holder L 90 is mounted on one end of the developing frame body 13, as shown in FIGS. 6 and 18. As will be described later, holders are mounted on the developing frame body 13 at the opposite ends thereof. So, in order to distinguish between them, the one designated by the reference numeral 90 is defined as a holder L, and the other one designated by the reference numeral 91 is defined as a holder R.

A bearing 92 for rotatably supporting the developing sleeve 12 is mounted on the holder L 90. The developing sleeve 12 is held by the holder L 90 through the bearing 92. The developing sleeve 12 can also supported by the developing frame body 13 through the holder L 90.

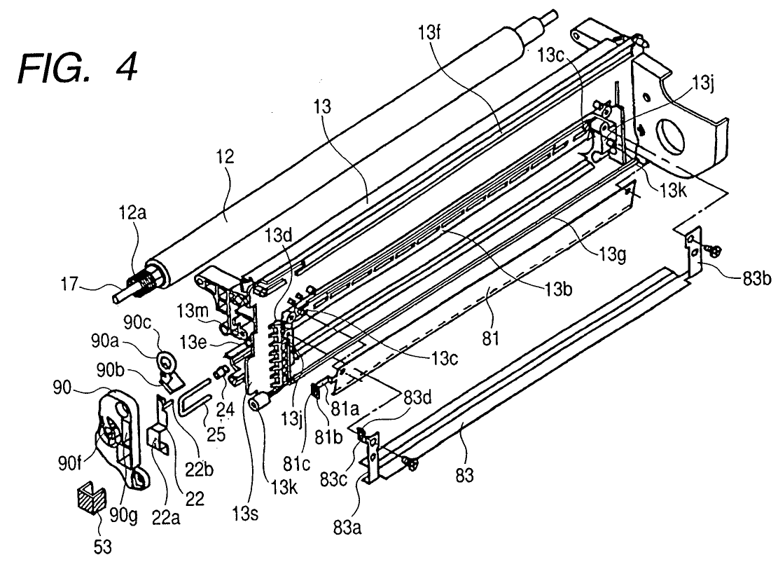

The holder L 90 is provided with a developing bias contact 90a for receiving a developing bias voltage from the image forming apparatus A and supplying it to the developing sleeve 12 (FIG. 4). Also, an electrical contact 22 for detecting the amount of toner which will be described later is mounted.

As described above, the holder L 90 has the bearing 92, the developing bias contact 90a and the electrical contact 22 incorporated therein. The holder L 90 is fixed to the developing frame body 13 with the developing sleeve 12 supported by the bearing 92. Also, the magnet 17 is held by a magnet supporting portion 90f provided on the holder L 90 and is supported on the developing frame body 13.

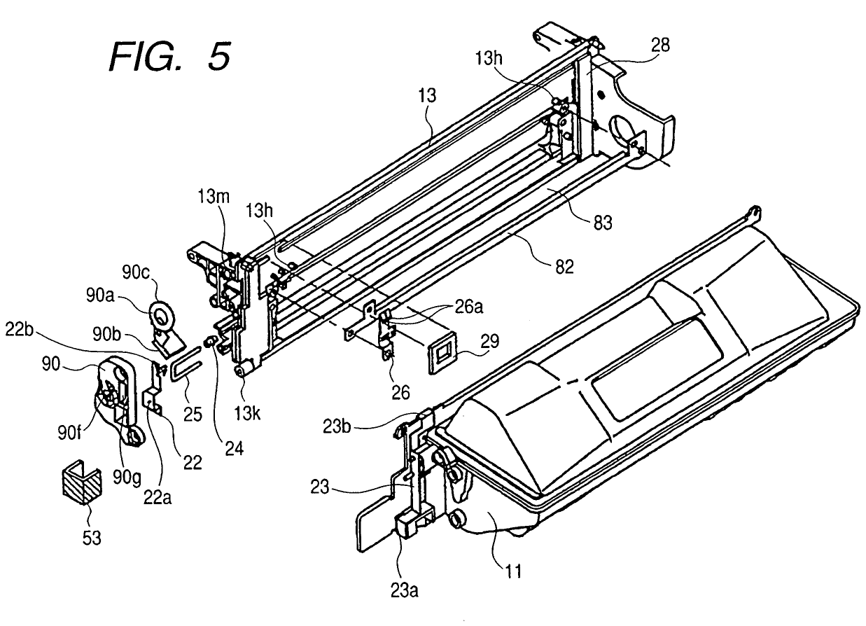

As shown in FIG. 6, the holder L 90 is fixed to the developing frame body 13 by a first screw 90d and a second screw 90e. Also, as shown in FIG. 5, a side of the developing frame body 13 is formed with a first screw hole 13m and a second screw hole 13k for receiving the first screw 90d and the second screw 90e, respectively, therein.

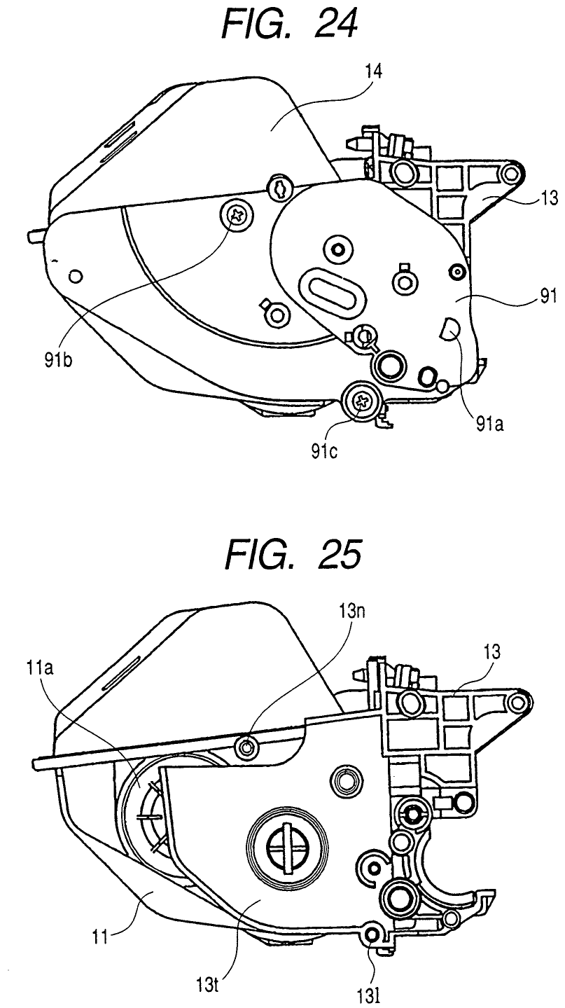

(Holder R) The holder R 91 is mounted on the other end of the developing frame body 13 lengthwisely opposite to the side on which the aforedescribed holder L 90 is mounted, as shown in FIGS. 18 and 24. Also, FIG. 17 is a view of the holder R 91 as it is seen from its inside.

The holder R 91 is provided with a magnet supporting portion 91a for fixedly supporting the magnet 17 contained in the developing sleeve 12 on the developing frame body 13. Thus, the magnet 17 is held by the holder R 91 with the aid of the magnet supporting portion 91a. The magnet 17 can also be supported by the developing frame body 13 through the holder R 91.

Also, the holder R 91, as shown in FIG. 17, holds various gears for drive transmission. Specifically, the holder R 91 has a first idler gear 93, a second idler gear 94, a toner container agitating gear 95 and a third idler gear 96 mounted thereon.

The first idler gear 93 receives driven force from a sleeve gear 97 for rotating the developing sleeve 12 at a predetermined peripheral speed which is shown in FIG. 18.

The second idler gear 94 receives driven force from the first idler gear 93.

The agitating gear 95 receives driven force from the second idler gear 94, and rotates the toner feeding member 15 provided in the toner containing part 14 which is shown in FIG. 2. The toner feeding member 15 feeds the toner in the toner containing part 14 into the developing chamber 13a.

The third idler gear 96 receives driven force from the agitating gear 95. It rotates a developing chamber agitating gear mounted on the toner agitating member 16 for agitating the toner in the developing chamber 13a. The toner agitating member 16 agitates the toner in the developing chamber 13a.

As described above, the holder R 91 has the first idler gear 93, the second idler gear 94, the agitating gear 95 and the third idler gear 96 incorporated therein. The holder R 91 is fixed to the developing frame body 13 with the magnet 17 supported by the magnet supporting portion 91a.

As shown in FIG. 24, the holder R 91 is fixed to the developing frame body 13 by a first screw 91b and a second screw 91c. Also, as shown in FIG. 25, the toner container 11 is formed with a first screw hole 13n for receiving the first screw 91b therein. The developing frame body 13 is formed with a second screw hole 13l for receiving the second screw 91c therein.

Also, as shown in FIG. 18, a bearing 92a for rotatably supporting the developing sleeve 12 is held by a bearing holder 98. The developing sleeve 12 is held on the developing frame body 13 by the positioning pins 91e and 91f of the holder R 91 shown in FIG. 17, through the bearing 92a and the bearing holder 98. Also, on the lengthwisely opposite side, as described above, the developing sleeve 12 is held on the developing frame body 13 through the bearing 92 and the holder L 90.

Also, the cartridge B is provided with first toner amount detecting means and second toner amount detecting means for detecting the residual amount of toner in accordance with the consumption of the toner in the developing chamber 13a.

(First Detecting Means)

In the present embodiment, the first detecting means is such that as shown in FIG. 2, a first electrode 81, a second electrode 82 and a third electrode 83 as measuring electrode members constituting a toner amount detecting portion are disposed along the developing sleeve 12. The first electrode 81 and the third electrode 83, as will be described later, are electrically connected together in the developing frame body 13 and are at the same potential. The detecting means applies a voltage to one of the first electrode 81 and the second electrode 82 to thereby induce a capacitance between the electrodes. This capacitance is measured to thereby detect the amount toner. In the present embodiment, the voltage is applied to the second electrode 82, which is used as an input side, and the first electrode 81 and the third electrode 83 are used as an output side.

The first electrode 81, the second electrode 82 and the third electrode 83 are disposed at locations into which the toner carried by the toner feeding member 15 comes. When the amount of toner in the cartridge B is great, the toner is pushed by the toner feeding member 15 into the space surrounded by the electrodes, and the capacitance between the electrodes continues to exhibit a high value. As the cartridge B is used, the toner is consumed and the height of the toner among the electrodes decreases and the capacitance also decreases. Finally, the toner near the distal end of the developing blade 18 for scraping off the toner on the surface of the developing sleeve 12 is consumed to thereby cause a blank on an image, and there is brought about a toner absent state.

In the present embodiment, the developing bias voltage applied to the developing sleeve 12 is used as an input voltage, and the capacitance between the developing sleeve 12 and the first electrode 81 is also detected to thereby detect the toner absent state. That is, the first detecting means can detect changes in the capacitance to thereby sequentially detect the amount of toner.

According to the image forming apparatus according to the present embodiment, the residual amount of toner in the cartridge B is sequentially detected. On the basis of the information, the consumed amount of toner is displayed to thereby call upon the user to prepare a fresh process cartridge or a supply cartridge. Further, it is possible to call upon the user to interchange the process cartridge or supply the toner by the detection information of toner absence.

(Second Detecting Means)

Description will now be made of a second toner amount detecting device. The second toner amount detecting device, as shown in FIG. 2, is a portion of the antenna rod 89 of an electro-conductive material, e.g. a metal wire, provided along the lengthwise direction of the developing sleeve 12.

The antenna rod 89, if made of an electro-conductive material, performs the same action, but in the present embodiment, a nonmagnetic SUS material is used for it so as not to affect the circulation of the toner. The antenna rod 89 is provided over the full length of the developing sleeve 12 at a predetermined distance from the developing sleeve 12.

The capacitance between this antenna rod 89 and the developing sleeve 12 is varied by the amount of toner present therebetween. So, a variation in this capacitance is detected as a variation in potential difference by the toner amount detecting contact of the image forming apparatus main body to thereby detect the amount of toner. The antenna rod 89 which is the second toner amount detecting device does not sequentially detect the amount of toner like the aforedescribed first toner amount detecting device, but effects only the detection of the vicinity of toner absence.

As described above, the cartridge B according to the present embodiment is provided with the two toner amount detecting devices. Thereby, the cartridge B is adapted to be capable of coping with both of an image forming apparatus main body having a mechanism for sequentially detecting the amount of toner and an image forming apparatus main body having no mechanism for sequentially detecting the amount of toner and effecting only the detection of toner absence.

Description will now be made of a construction for mounting the first electrode 81, the second electrode 82 and the third electrode 83 in the first toner amount detecting device and the antenna rod 89 which is the second toner amount detecting device onto the constructive portion of the developing apparatus.

The toner amount detecting devices provided by the first electrode 81, the second electrode 82, the third electrode 83 and the antenna rod 89 are materialized by detecting the space surrounded by the first electrode 81, the second electrode 82 and the third electrode 83, or the capacitance between the antenna rod 89 and the developing sleeve 12. Accordingly, the positional accuracy of each electrode is very important. Particularly the intervals among the first electrode 81, the second electrode 82 and the third electrode 83 and the position of each electrode relative to the developing sleeve 12 and the developing blade 18 need be accurate in order to detect the amount of toner accurately.

Also, to accurately detect the time when the toner becomes exhausted and a blank on an image occurs, each electrode should be disposed near the developing sleeve 12 on which the toner remains to the last.

So, in the present embodiment, as shown in FIGS. 4, 5 and 8, the first electrode 81, the second electrode 82, the third electrode 83 and the antenna rod 89 are mounted on a developing frame, i.e., the developing frame body 13.

(Mounting of the Electrodes)

The first electrode 81 is positioned by a positioning boss 13c provided on the mounting surface 13b of the developing frame body 13, and is stuck on the mounting surface 13b by a both-side tape (see FIG. 4). The method of mounting the electrode is not restricted to the both-side tape, yet the first electrode 81 is provided near the developing sleeve 12 and the developing blade 18 on which the toner is consumed lastly, in order to detect the blank on the image accurately. Consequently, in some cases, it is difficult to secure a space for fastening screws to the developing frame body 13. Accordingly, in the present embodiment, the fixing by the both-side tape which does not require such a space is adopted.

There is an arm portion (hook) 81a on one end portion of the first electrode 81, and that end portion is formed with a knocked-up portion 81b. The knocked-up portion 81b is adapted to come into the groove 13d of the developing frame body 13 when the first electrode 81 is mounted on the developing frame body 13. On the other hand, laterally of the groove 13d of the developing frame body 13, there is a hole 13e extending through the interior of the frame body to the outside, and the location thereof is designed to coincide with that of the hole 81c of the knocked-up portion 81b.

The third electrode 83 has arm portions 83a and 83b on the opposite ends thereof, and these arm portions are placed on and fixed to the mounting portions 13i and 13j of the developing frame body 13 by screws. A knocked-up portion 83c similar in shape to the knocked-up portion 81b of the first electrode 81 is formed on the end of the arm portion 83a. The knocked-up portions 83c and 81b are designed to be in line when the third electrode 83 is mounted on the developing frame body 13.

The third electrode 83 is mounted on the developing frame body 13 after the mounting of the first electrode 81. When the third electrode 83 is incorporated, the knocked-up portion 83c contacts with the arm portion 81a of the first electrode 81. In this state, the holes of the knocked-up portions 81b and 83c come to be in line. Thereby, the knocked-up portion 83c of the third electrode 83 corrects the position of the knocked-up portion 81c of the first electrode 81 to thereby improve the assembling property of the press-in of the electrode bar 25 thereafter.

Also, the hole 13e of the developing frame body 13 is of a shape into which such an elastic seal member 24 as is disclosed in Japanese Patent Application Laid-Open No. H 8-314359 is fitted, and the elastic seal member 24 is pressed thereinto from the outside of the developing frame body.

Thereafter, the electrode bar 25 is inserted into the developing frame body 13 through the elastic seal member 24. The electrode bar is then pressed into the knocked-up portion 81b of the first electrode 81 and the knocked-up portion 83c of the third electrode 83, and the first electrode 81 and the third electrode 83 are electrically connected together.

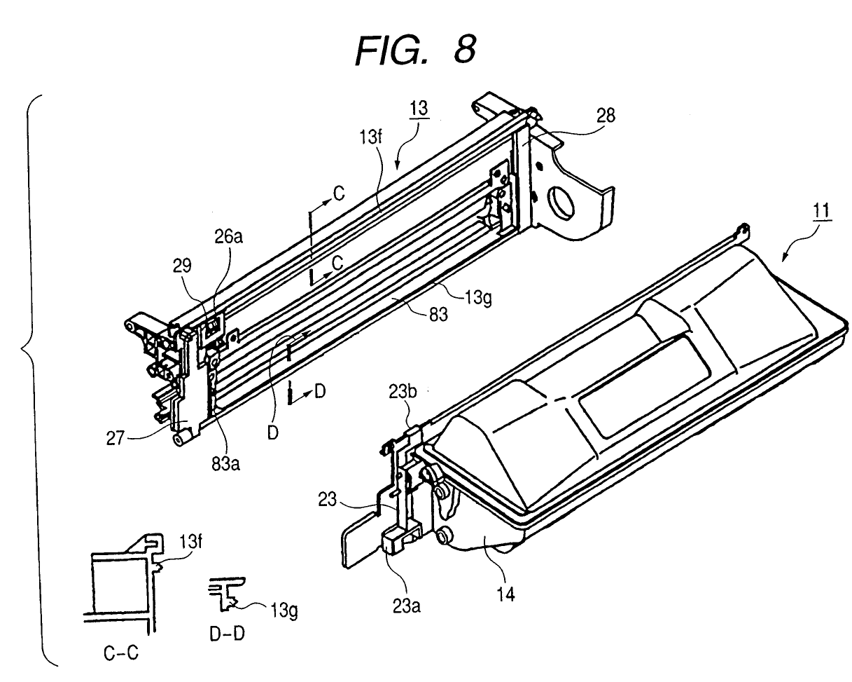

As shown in FIGS. 5 and 8, the second electrode 82 is positioned by the positioning boss 13h of the developing frame body 13 and is fixed by screws. In this case, one of the screws fastens an electrode plate 26 and the second electrode 82 together, and effects wiring to the outside of the developing frame body 13. It is desirable that the second electrode 82 be assembled after the mounting of the first electrode 81 so as not to spoil the assembling property of the first electrode 81.

Description will now be made of a coupling construction for the developing frame body 13 and the toner container 11 having the toner containing part 14.

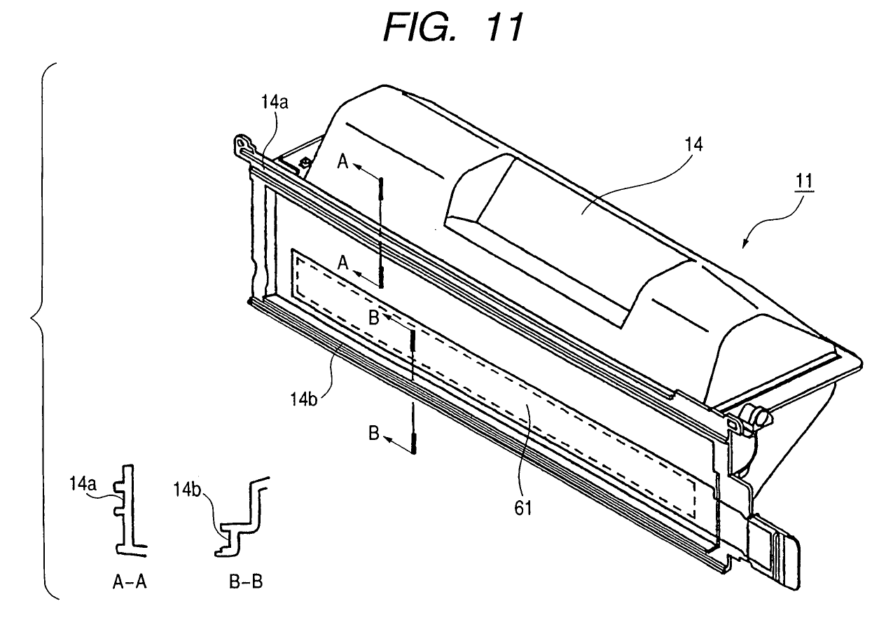

As shown in FIGS. 8 and 11, the joined surface of the developing frame body 13 to the toner container 11 is formed with convex portions 13f and 13g fitted into coupling concave grooves 14a and 14b, respectively, formed in the toner containing part 14. On the top surfaces of these convex portions 13f and 13g, there are provided triangular ribs for use when ultrasonic welding is effed, as shown in cross-sectional views C-C and D-D in FIG. 8. Also, seal members 27, 28 and 29 for preventing the leakage of the toner from between the developing frame body 13 and the toner containing part 14 are stuck around the opposite end portions of the developing frame body 13 and the contact portion 26a of the electrode plate 26. As the seal members 27, 28 and 29, use is made of a sponge-like material.

The developing frame body 13 and the toner container 11 after each part has been incorporated thereinto are pressed with the convex portions 13f and 13g of the developing frame body fitted in the concave grooves of the toner containing part 14, and ultrasonic vibration is applied to between the concave grooves and the convex portions. Thereupon, the triangular ribs are melted by frictional heat and are welded to the bottoms of the concave grooves, whereby the developing frame body 13 and the toner container 11 are coupled integrally with each other.

In the present construction, an electrical contact 23 is attached to the toner container 11. The electrical contact 23 is provided with a contact portion 23a with the image forming apparatus main body and a contact portion 23b with the electrode plate 26, and the contact portion 23b and the electrode plate 26 are electrically connected together when the developing frame body 13 and the toner container 11 are coupled together.

(Assembly of the Holder L and Connection of the Electrical Contact)

As shown in FIG. 4, the electrical contact 22 is provided with a contact portion 22a, which contacts with the electrode bar 25 when the holder L 90 is mounted on the developing frame body 13. Consequently, the electrical contact 22 and the first electrode 81 and the third electrode 83 are electrically connected together.

Also, a contact spring 12a provided on one end of the developing sleeve 12 is electrically connected to a contact portion 90c provided on a developing bias contact 90a. A predetermined developing bias is applied to the developing sleeve 12.

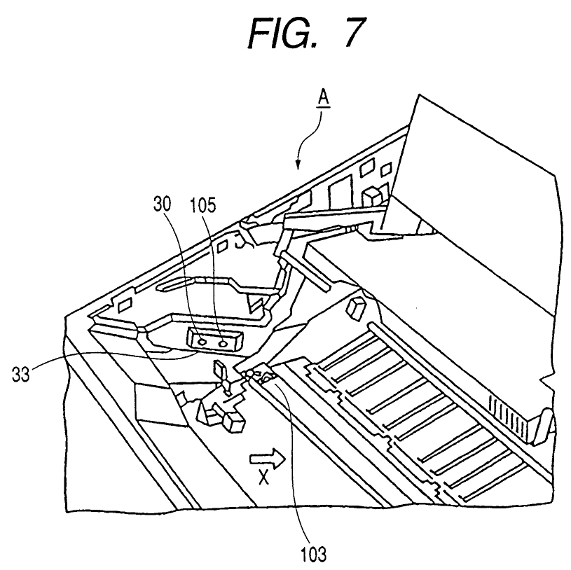

On a side of the thus assembled cartridge B, as shown in FIG. 6, there are disposed the electrical contacts 22 and 23 of the toner amount detecting device and the developing bias contact 90a. Thereby, these contacts, as shown in FIG. 7, are electrically connected to toner amount detecting contacts 30, 105 and a developing bias contact 103 disposed in the image forming apparatus main body when the cartridge B is mounted on the image forming apparatus A in the direction of X.

[Method of Disassembling and Reproducing the Process Cartridge B]

(Method of Disassembling the Cartridge B)

Description will now be made of a method of disassembling the cartridge B. The process of disassembling is shown in FIG. 30.

First, the aforedescribed coupling pin 40 is pulled out from the outside or pushed out from the inside to thereby divide the unit C and the developing unit D.

The unit C is reproduced by cleaning the waste toner in the waste toner reservoir 9b, and reproducing or interchanging the photosensitive drum 7, the cleaning means 9 comprised of the cleaning blade 9a, etc. and the charging roller 8.

(Method of Disassembling the Developing Unit D)

The first screw 90d and the second screw 90e shown in FIG. 6 are removed to thereby remove from the developing frame body 13 the holder L 90 which is a supporting member fixed to the developing frame body 13. Also, the first screw 91b and the second screw 91c shown in FIG. 24 are removed to thereby remove from the developing frame body 13 the holder R 91 which is a supporting member (the step of removing the supporting member, S1 in FIG. 30).

Thereafter, the developing sleeve 12 and the developing blade 18 are removed, and the developing frame body 13 and the toner container 11 are separated from each other (the step of separating the developing frame body S2 in FIG. 30).

As previously described, the developing frame body 13 and the toner container 11 are coupled together as by ultrasonic welding and cannot be easily separated from each other.

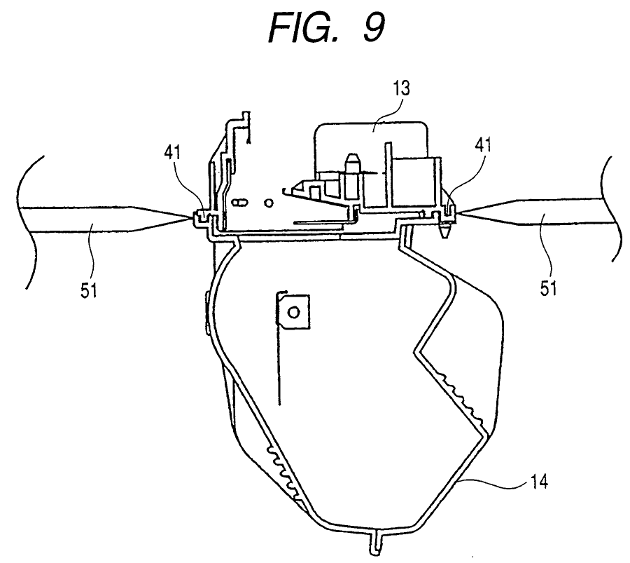

So, to separate the developing frame body 13 and the toner container 11 from each other, the welded surfaces thereof are cut by a cutter 51 as shown in FIG. 9, or cut by ultrasonic cutting work (not shown) or laser beam machining or the like (not shown).

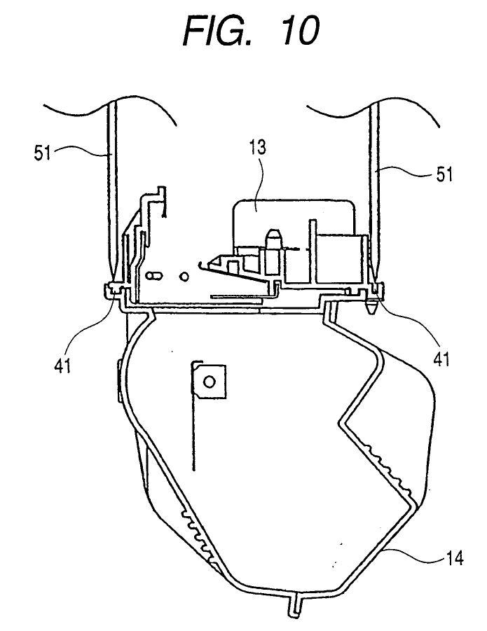

Describing the case of the cutter 51, the place to be cut is the joined surface 41 which is a welded joint portion as shown in FIG. 9. Otherwise, as shown in FIG. 10, the welded portion may be evaded and cutting may be done along the joined surface 41. The ultrasonic cutting work is also similar in that ultrasonic vibration is applied to the cutter 51. In the case of the laser beam machining, the reach distance of a laser beam is designed to be limited to the portion to be cut.

(Method of Coupling the Developing Frame Body 13 and the Toner Container 11 Together)

The cleaning of the toner in the toner containing portion 14 provided in the separated toner container 11. Then, as shown in FIG. 11, a toner seal member 61 is fixed to the opening portion which is a toner supplying opening by heat welding, bonding, a both-side tape or the like to thereby reseal the opening portion (the sticking step, S3 in FIG. 30). The opening portion provided in the toner containing part 14 is provided on a side opposed to the developing frame body 13 for the purpose of supplying the toner toward the photosensitive drum 7.

After the toner seal member 61 has been stuck, refill with a fresh toner is effected (the step of refilling with the developer, S4 in FIG. 30).

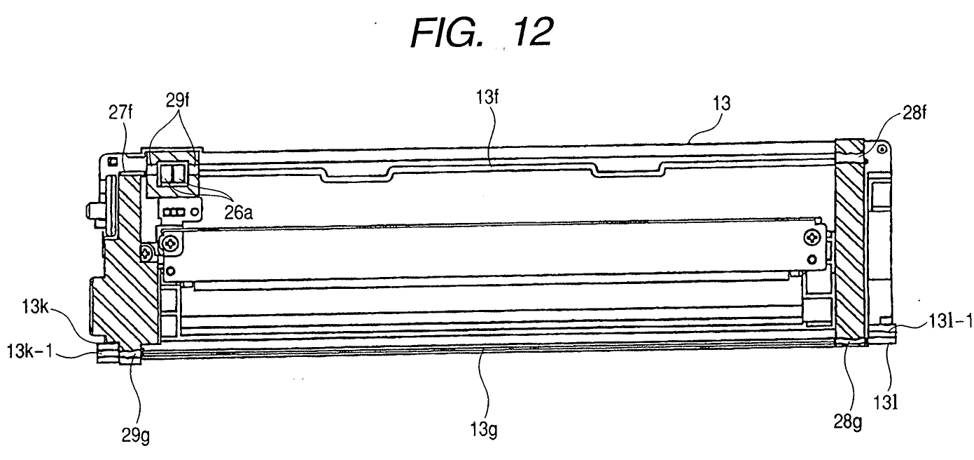

The disassembled developing frame body 13, as shown in FIG. 12, is in a state in which the overlapping portions 27f, 28f, 29f, 28g and 29g of the triangular ribs of the convex portions 13f and 13g melted and coupled together by an ultrasonic wave during coupling and the convex portions 13f and 13g of the seal members 27, 28 and 29 are melted and solidified. Therefore, it is necessary to seal so that the toner may not leak from these portions when recoupling has been done.

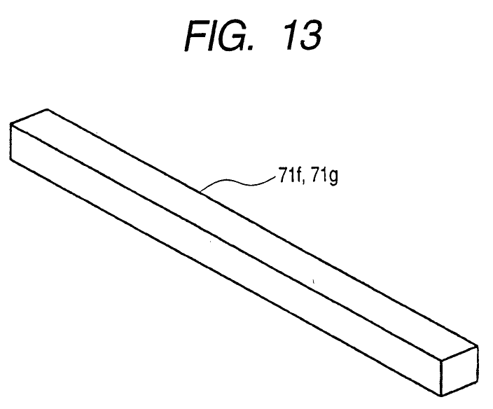

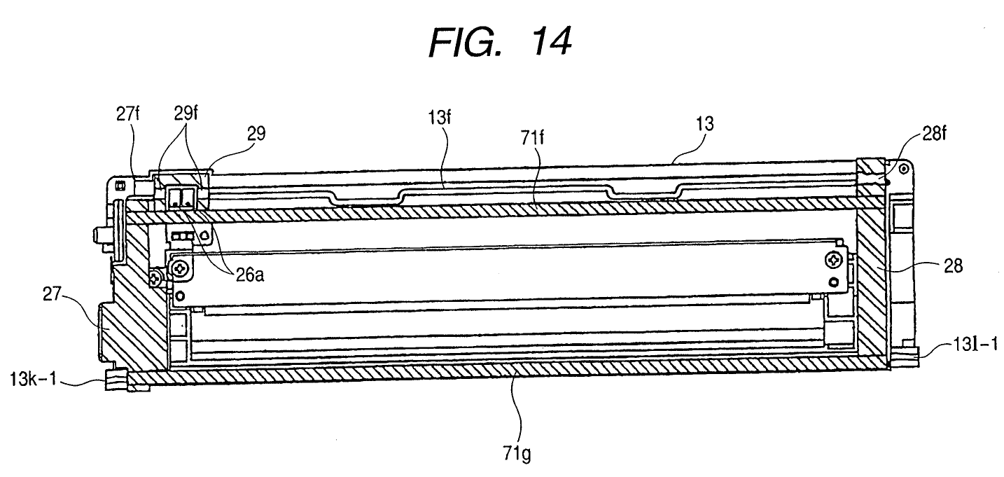

So, as shown in FIG. 14, a sponge-like seal member 71f (see FIG. 13) is stuck on the opening side of the toner containing part 14 rather than on the overlapping portions 27f, 28f and 29f, astride the seal members 27, 28 and 29, to thereby seal the upper side of the frame body. Likewise, a seal member 71g is stuck on the opening side rather than on the overlapping portions 28g and 29g shown in FIG. 12 to thereby seal the lower side of the frame body.

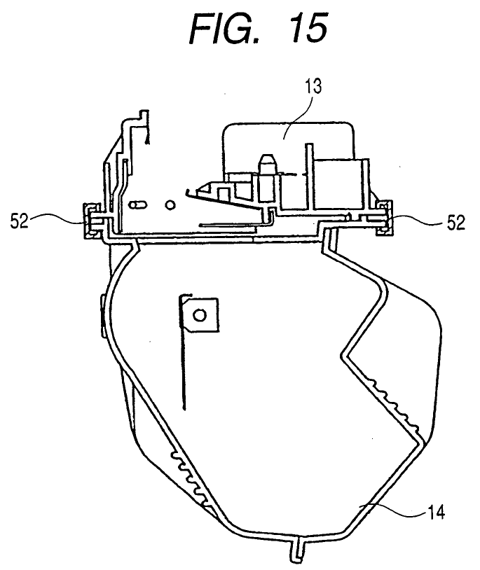

Thereafter, the reproduced developing frame body 13 and toner container 11 are coupled together by coupling fittings 52 which is a clip made of a spring material having a U-shaped cross section as shown in FIG. 15 (the developing frame body coupling step: S5 in FIG. 30).

Regarding the coupling of these, however, it is also possible to accomplish it by the use of not only the coupling fittings 52, but a method such as screwing, bonding, both-side tape sticking, ultrasonic welding or heat welding.

(Mounting of the Sleeve Unit)

The bearing 92a, a bearing holder 98 for supporting it, the developing sleeve 12 and the developing blade 18 are mounted on the coupled developing frame body 13 by diversion, reproduction or interchange.

(Mounting of the Holders)

Due to the above-described separation (by cutting) of the developing frame body 13 and the toner container 11, second screw holes 13k and 13l for fixing the holder L 90 and the holder R 91 to the developing frame body 13 become unusable. That is, these second screw holes 13k and 13l are cut along the cutting surface of a cutter 51 by the cutter 51. Then, as shown in FIG. 12, cutting surfaces 13k-1 and 13l-1 are formed on the lengthwise extensions of the triangular ribs.

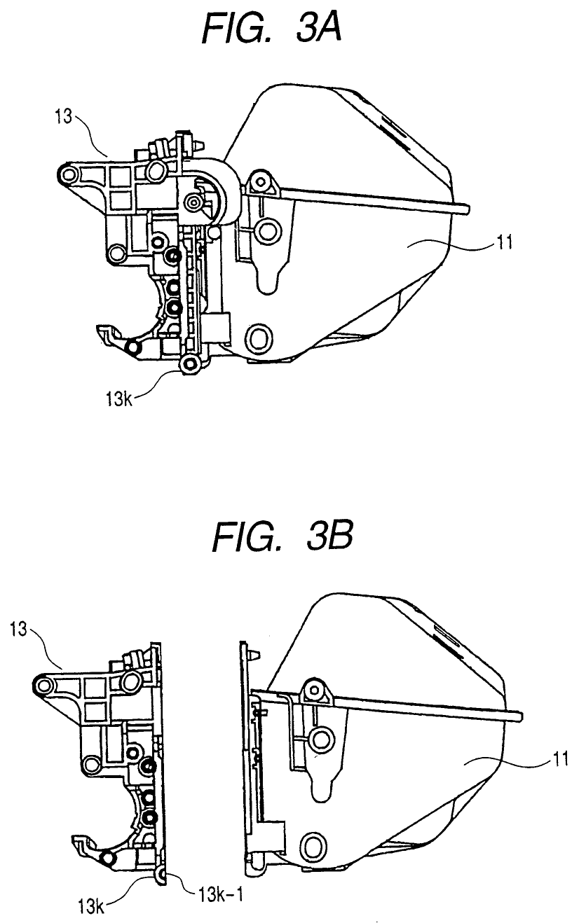

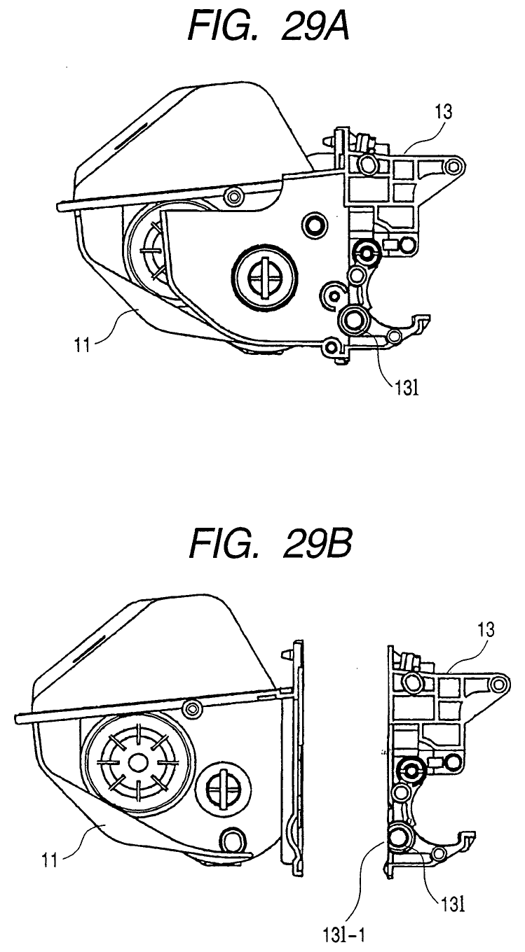

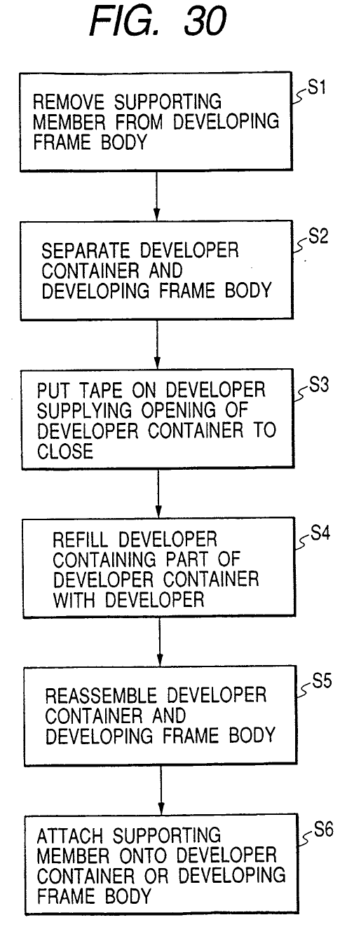

That is, the second screw holes 13k and 13l are provided on the lengthwise extension on the joined surface 41 which is the joint portion of the developing frame body 13 with the toner container 11 and near the joined surface 41. Consequently, the second screw holes 13k and 13l are also cut when as shown in FIGS. 9 and 10, the developing frame body 13 and the toner container 11 are separated from the joined surface 41 by the use of the cutter 51. FIGS. 3A and 29A show the states of the second screw holes 13k and 13l before the developing frame body 13 is separated from the toner container 11. Also, FIGS. 3B and 29B show the states of the second screw holes 13k and 13l after the separation. As can be seen from these figures, the second screw holes 13k and 13l are cut into a state in which they cannot be used again as screw holes. Separating the developing frame body 13 from the toner container 11 in such a manner as not to damage the second screw holes 13k and 13l requires the cutting work by the cutter 51 to be done cautiously, and requires many working steps (a long time). Consequently, when the number of working steps is taken into account, it is more efficient to cut the second screw holes 13k and 13l provided on the lengthwise extensions on the joined surface 41 and near the joined surface 41 when the cutting work by the cutter 51 is done, and the number of the working steps can be improved.

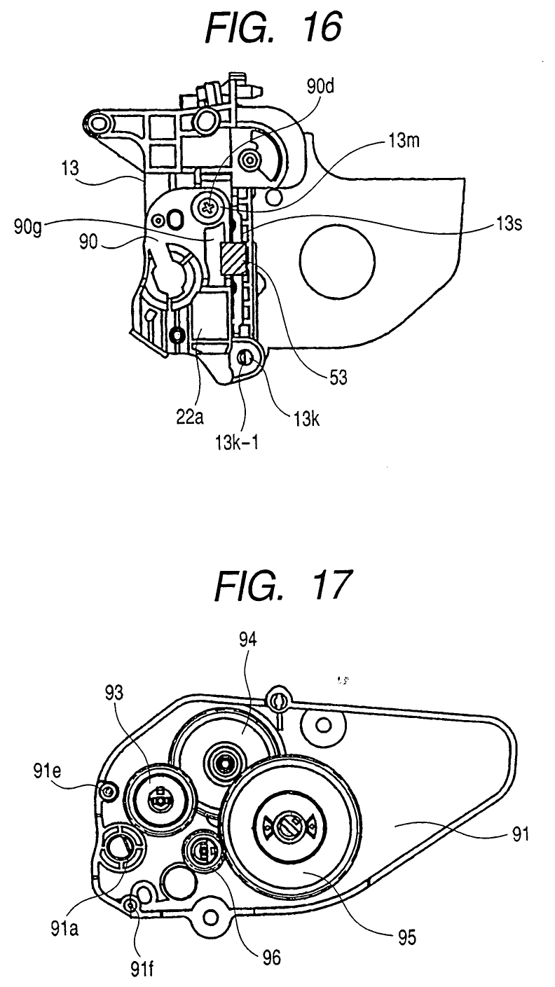

Therefore, the screwing by these second screw holes 13k and 13l becomes impossible when reassembly which will be described later is effected thereafter. Accordingly, screwing portions for fixing the holder L 90 and the holder R 91 to the developing frame body 13 become first screw holes 13m and 13n alone, as shown in FIGS. 16 and 19.

However, fixing each holder to the developing frame body 13 by only one screw, as compared with fixing each holder to the developing frame body 13 by two screws, is reduced in fastening force relative to the developing frame body 13. Therefore, the supported state of the parts supported by each holder relative to the developing frame body 13 may be aggravated to thereby give rise to the following problems.

The supporting of the developing sleeve 12 rotatably supported by the holder L 90 through the bearing 92 becomes unstable as compared with a case where the holder L 90 is screwed by two screws. That is, with the driving of the developing sleeve 12, the bearing 92 and the holder L 90 supporting the developing sleeve 12 cause vibration or positional deviation, and this leads to the aggravation of the quality of image.

Also, the supporting of the magnet 17, the first idler gear 93, the second idler gear 94, the toner container agitating gear 95 and the third idler gear 96 supported relative to the developing frame body 13 by the holder R 91 becomes unstable and causes vibration, and this leads to the aggravation of the quality of image.

Also, the electrical contact 22 and the developing bias contact 90a assembled to the holder L 90 are electrically connected to the contact portions 105 and 103, respectively, of the image forming apparatus A shown in FIG. 7. If, however, the fixing of the holder L 90 to the developing frame body 13 is unstable, the connected states of the electrical contact 22 and the developing bias contact 90a to the contact portions 105 and 103 become unstable due to vibration, positional deviation or the like, and this may cause faulty conduction.

So, in order to solve these problems, it is necessary to effect the fixing of the holder R 91 and the holder L 90 firmly.

So, by one of the following methods, the holder R 91 and the holder L 90 are fixed to respective fixing portions by the use of coupling fittings 53-56 (the supporting member mounting step: S6 in FIG. 30). The coupling fittings 53-56 are made of such a U-shaped spring material as shown in FIG. 23, and have such predetermined spring pressure as can firmly fix the holders and each portion when they are to be fixed.

(First Fixing Method: Holder L 90 and Developing Frame Body 13)

FIG. 16 shows a state in which the holder L 90 is mounted in a first screw hole 13m of the developing frame body 13 by a screw 90d.

A second screw hole 13k is formed with a cutting surface 13k-1 by the cutting by the cutter, and it is impossible to fix the holder L 90 to the developing frame body 13 by the use of the second screw hole 13k.

So, design is made such that the coupling fittings 53 are mounted so as to sandwich the holder L 90 and the developing frame body 13 to thereby fix the two firmly.

More particularly, design is made such that a concave portion 90g formed in the outer side of the mounting surface of the electrical contact 22 which is provided on the holder L 90 and the mounting portion 13s of the developing frame body 13 for the seal member 27 are fixed by the coupling fittings 53 (see FIGS. 4 and 16).

The mounting location for the coupling fittings 53 may be any location at which the holder L 90 and the developing frame body 13 can be fixed firmly. That is, the coupling fittings 53 may be mounted at any location except a location which will hinder the insertion thereof into the electrophotographic image forming apparatus A, a location which will hinder the assembling of the unit C, the electrical contact portions, etc.

(Second Fixing Method: Holder R 91 and Developing Frame Body 13)

FIG. 19 show a state in which the holder R 91 is mounted in a first screw hole 13n of the developing frame body 13 by a screw 91b.

A second screw hole 13l is formed with a cutting surface 13l-1 by the cutting by the cutter, and it is impossible to fix the holder R 91 to the developing frame body 13 by the use of the second screw hole 13l.

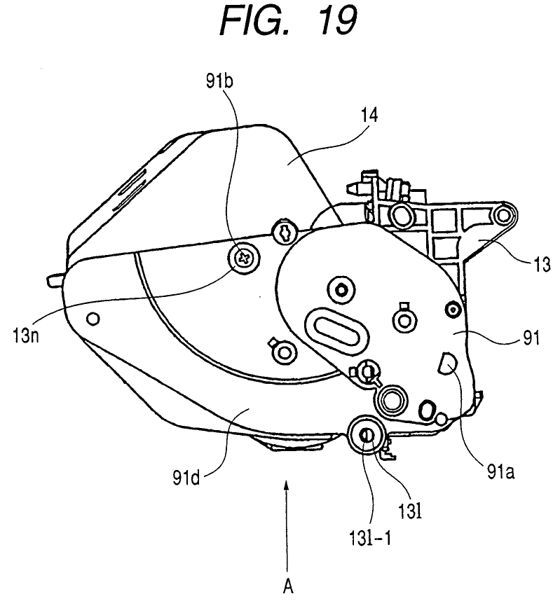

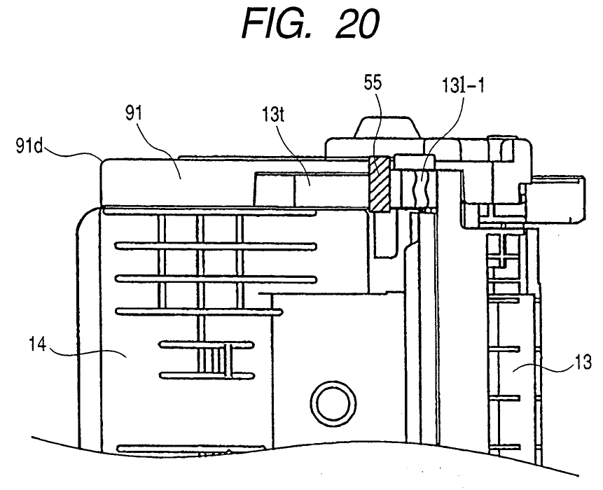

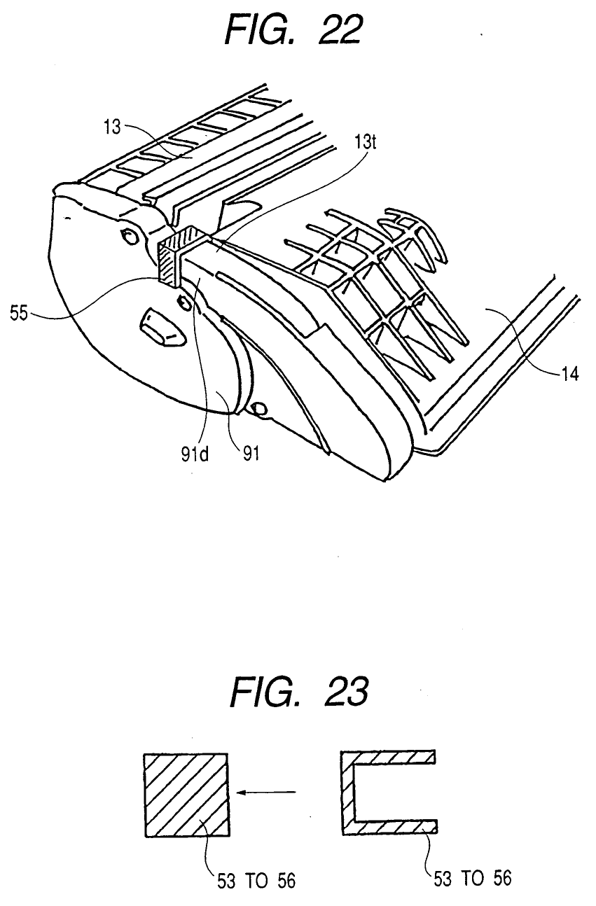

So, as shown in FIGS. 20 and 22, the coupling fittings 55 are mounted so as to sandwich the holder R 91 and the developing frame body 13 to thereby fix the two (FIG. 20 is a view taken along the direction of arrow A in FIG. 19, and FIG. 22 is a perspective view corresponding to FIG. 20).

More particularly, design is made such that the outer end surface 91d of the holder R 91 shown in FIGS. 20 and 22 and the side plate 13t of the developing frame body 13 shown in FIG. 25 are fixed by the coupling fittings 55. The side plate 13t covers a portion of a toner cap 11a provided on the toner container 11 shown in FIG. 25.

However, the mounting location for the coupling fittings 55 may be any location at which the holder R 91 and the developing frame body 13 can be fixed firmly. That is, the coupling fittings 55 may be mounted at any location except a location which will hinder the insertion thereof into the electrophotographic image forming apparatus A, a location which will hinder the assembling of the unit C, etc.

(Third Fixing Method: Holder R 91 and Toner Container 11)

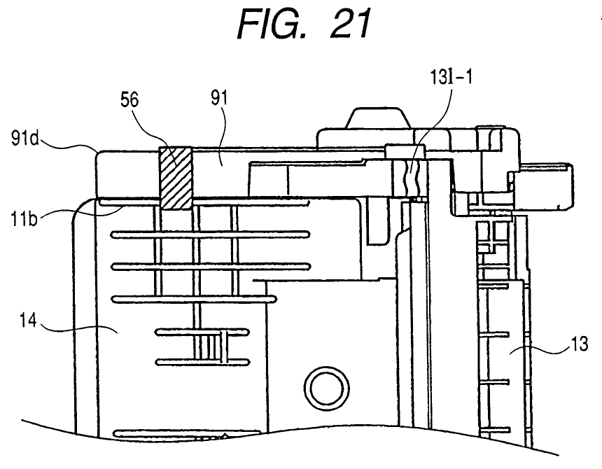

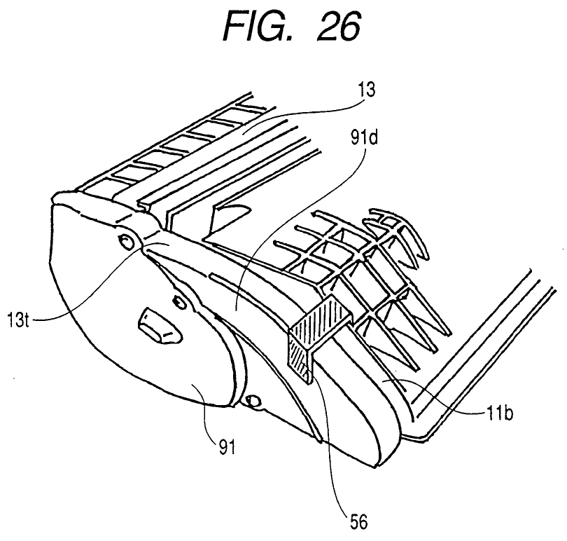

FIGS. 21 and 26 show a state in which the holder R 91 is fixed to the toner container 11 by coupling fittings 56 (FIG. 21 is a view taken along the direction of arrow A in FIG. 19, and FIG. 26 is a perspective view corresponding to FIG. 21).

The outer end surface 91d of the holder R 91 and a reinforcing rib 11b provided in the toner container 11 which is shown in FIGS. 21 and 26 are fixed by the coupling fittings 56.

(Summary of the Fixing Method)

The fixing method for the holder R 91 and the holder L 90 can be carried out by suitably combining the methods as described above.

(Assembling of the Process Cartridge)

Next, assembling is effected by a procedure opposite to disassembling. However, the parts of the unit C and the developing unit D are suitably inspected and reusable ones are cleaned and thereafter assembled, and unreusable parts are interchanged to new parts and the assembling thereof is effected. Thereafter, the assembled unit C and developing unit D are coupled together by the coupling pin 40 and are reproduced as a process cartridge.

The above-described embodiment of the present invention can be summarized and supplemented as follows.

A method of reproducing a process cartridge or a developing apparatus provided with:

a toner container 11 containing therein a toner which is a developer;

a developing frame body 13 coupled to the toner container 11; and

a holder (at least one of a holder L 90 and a holder R 91) for holding at least one (e.g. a developing sleeve 12) of the constituent parts of developing means 10 mounted on one end of the developing frame body 13 for developing a latent image on a photosensitive drum 7 as an image bearing member by the use of the toner in the toner container 11, the process cartridge or the developing apparatus being made detachably attachable to an image forming apparatus, has the steps of:

removing the holder from the developing frame body 13;

separating the toner container 11 and the developing frame body 13 from each other;

sticking a toner seal member 61 for closing a toner supplying opening portion provided in that side of the toner container 11 which is adjacent to the developing frame body 13;

filling (refilling) the toner container 11 with the toner;

coupling the toner container 11 and the developing frame body 13 together; and

coupling at least one of the toner container 11 and the developing frame body 13, and the holder together by the use of a coupling member.

The coupling member used to couple at least one of the toner container 11 and the developing frame body 13, and the holder together will be described here.

As described above, design is made such that the holder is fixed to at least one of the toner container 11 and the developing frame body 13 by the coupling fittings 53-56 to thereby increase the fixing strength of the holder. Thereby, the member held by this holder is stably positioned, whereby it is made possible to form an image of high quality.

As the coupling fittings 53-56, there has specifically been shown an example which adopts a sandwiching member for sandwiching two members to be coupled together, by the use of a member having a U-shaped cross section, as shown in FIG. 23.

However, the coupling member is not restricted to such one. That is, any member which can fix the holder to at least one of the toner container 11 and the developing frame body 13 is applicable.

As described above, however, in the present embodiment, the loss caused by the screwing holes becoming unusable to thereby reduce the fixing force at the step of separating the toner container 11 and the developing frame body 13 from each other is made up for. Therefore, there is the purpose of increasing the fixing force by the coupling member.

Suitable as this coupling member is one which enables coupling to be accomplished by simple work and which occupies a small space. Accordingly, besides the sandwiching member as described above, an adhesive tape or the like can also be suitably used.

Description will now be made of a specific example of the holder which becomes the object in the above-described reproducing process.

The holder rotatably holds the developing sleeve 12 for carrying the toner to a developing position while carrying thereon the toner in the toner container 11, through the bearing 92. That is, in the above-described example, the holder L 90 can be the object.

In this case, the holder L 90 is firmly fixed to at least one of the toner container 11 and the developing frame body 13. Therefore, the positional deviation, the vibration or the like of the developing sleeve 12 can be reduced, and this contributes to an improvement in the quality of image.

Also, the holder holds the magnet 17 contained in the developing sleeve 12 for carrying the toner to the developing position while carrying thereon the toner in the toner container 11. That is, in the above-described example, the holder R 91 can be applied.

In this case, the holder R 91 is firmly fixed to at least one of the toner container 11 and the developing frame body 13. Therefore, the positional deviation, the vibration or the like of the magnet 17 can be reduced, and this contributes to the improvement in the quality of image.

Also, the holder holds drive transmitting gears (the first idler gear 93, the second idler gear 94, the toner container agitating gear 95 and the third idler gear 96) having a gear (the first idler gear 93) for transmitting the driving force from the developing sleeve 12 for carrying the toner to the developing position while carrying thereon the toner in the toner container 11. That is, in the above-described example, the holder R 91 can be applied.

In this case, the holder R 91 is firmly fixed to at least one of the toner container 11 and the developing frame body 13. Therefore, the positional deviation, the vibration or the like of each drive transmitting gear can be reduced and drive transmission becomes smooth, and this contributes to the improvement in the quality of image.

Further, the holder holds the electrical contact portion (electrical contacts 22 and 23) which is an intermediary portion for the exchange of electricity between the image forming apparatus main body side and the process cartridge side. That is, in the above-described example, the holder L 90 can be applied.

In this case, the holder L 90 is firmly fixed to at least one of the toner container 11 and the developing frame body 13. Therefore, faulty electrical contact or the like can be prevented, and this contributes to the improvement in the quality of image.

As described above, according to the embodiment of the present invention, it is not necessary to adopt a complicated working method in the separating work for the developing frame body 13 and the toner container 11. That is, even if cutting and separation are effected by the cutter or the like, there can be reproduced a process cartridge or a developing apparatus which is high in quality. Accordingly, in the work of separating the frame body, any excess number of steps can be curtailed and a simple step suffices.

Also, the holder and the developing frame body 13 or the toner container 11 can be firmly fixed to each other. Therefore, the stability of each member held by the holder increases and a faulty image which may occur from the instability of each member can be prevented.

The steps in the reproducing method of the present invention are not restricted to the aforedescribed order of steps, but may be suitably changed in order.

The present invention also covers any of the following cases.

(1) A case where in reproducing a process cartridge, only the parts removed from the process cartridge are reused to effect the reproduction of the cartridge.

(2) A case where in the aforedescribed case (1), regarding parts which cannot be reused because of having reached the end of their lives or being damaged, the reproduction of a cartridge is effected by the use of new parts or reusable parts removed from other cartridge.

(3) A case where in reproducing a process cartridge, parts removed from a plurality of process cartridges are once gathered by each kind of parts, and necessary parts are selected from among the parts gathered by each kind of parts, and those parts are reused to effect the reproduction of the cartridge.

(4) A case where in the aforedescribed case (3), regarding parts which cannot be reused because of having reached the end of their lives or being damaged, new parts are used to effect the reproduction of the cartridge.

The aforementioned parts are articles constituting the construction described in the appended claims, i.e., constituting some portions of a cartridge. They also cover a minimum unit or a unit which can be disassembled.

As described above, according to the present invention, the reproduction of a process cartridge and a developing apparatus can be effected easily. Also, it has become possible to simply effect the coupling of a toner container and a developing frame body. Further, it has become possible to simply and reliably mount a developing member on the developing apparatus and the process cartridge.

What is claimed is:

1. A method of reproducing a developing apparatus detachably attachable to an electrophotographic image forming apparatus main body and for developing a latent image formed on an electrophotographic photosensitive member, said developing apparatus having a developing member for developing said latent image formed on said electrophotographic photosensitive member, a developer container having a developer containing part containing therein a developer to be used by said developing member, and provided with a developer supplying opening for supplying the developer contained in said developer containing part to said developing member, a supporting member provided on a lengthwise end portion of said developing apparatus for supporting said developing member, and a developing frame body provided with a developer passing opening for passing therethrough the developer supplied from said developer supplying opening, and having a joint portion to be joined to said developer container, and a mounting portion for mounting said supporting member, the method comprising:
a supporting member removing step of removing said supporting member from said developing frame body;
a developing frame body separating step of separating said developer container and said developing frame body from each other in said joint portion, and at which at least a portion of said mounting portion is removed when said developer container and said developing frame body are separated from each other;
a sticking step of sticking a seal member for closing said developer supplying opening provided in said developer container separated at said developing frame body separating step;
a developer refilling step of refilling said developer containing part provided in said developer container separated at said developing frame body separating step with the developer;
a developing frame body coupling step of coupling said developer container and said developing frame body separated at said developing frame body separating step together after said sticking step; and
a supporting member attaching step of attaching said supporting member removed at said removing step onto at least one of said developer container and said developing frame body by the use of a coupling member.

2. A method according to claim 1, wherein said developing frame body is joined to said developer container in said joint portion by ultrasonic welding, and at said developing frame body separating step, said developer container and said developing frame body are separated from each other by the use of a cutter.

3. A method according to claim 1, wherein said developing frame body is joined to said developer container in said joint portion by ultrasonic welding, and at said developing frame body separating step, said developer container and said developing frame body are separated from each other by the use of a laser.

4. A method according to claim 1, wherein at said supporting member attaching step, said coupling member is mounted with said supporting member and said developing frame body sandwiched thereby.

5. A method according to claim 1, wherein at said supporting member attaching step, said coupling member is mounted with said supporting member and said developer container sandwiched thereby.

6. A method according to claim 4 or 5, wherein said coupling member is constituted by a U-shaped spring material.

7. A method according to claim 6, wherein said coupling member is constituted by a plate spring material.

8. A method according to claim 1, wherein said mounting portion is a boss having a screw hole for attaching said supporting member by a screw, and at said developing frame body separating step, a portion of said boss is removed.

9. A method according to claim 1, wherein said supporting member has driving force transmitting means for transmitting a driving force to said developing member, and at said supporting member removing step, said supporting member is removed from said developing frame body while holding said driving force transmitting means, and at said supporting member attaching step, said supporting member is attached onto said developing frame body while holding said driving force transmitting means.

10. A method according to claim 1, wherein said supporting member has a developing bias contact for contacting with said developing member and supplying a voltage to said developing member, and at said supporting member removing step, said supporting ember is removed from said developing frame body while holding said developing bias contact, and at said supporting member attaching step, said supporting member is attached onto said developing frame body while holding said developing bias contact.

11. A method of reproducing a process cartridge detachably attachable to an electrophotographic image forming apparatus main body, said process cartridge having a developing member for developing a latent image formed on an electrophotographic photosensitive member, said electrophotographic photosensitive member, a developer container having a developer containing part containing therein a developer to be used by said developing member, and provided with a developer supplying opening for supplying the developer contained in said developer containing part to said developing member, a supporting member provided on a lengthwise end portion of said process cartridge for supporting said developing member, and a developing frame body provided with a developer passing opening for passing therethrough the developer supplied from said developer supplying opening, and having a joint portion to be joined to said developer container, and a mounting portion for mounting said supporting member, the method comprising:
a supporting member removing step of removing said supporting member from said developing frame body;
a developing frame body separating step of separating said developer container and said developing frame body from each other in said joint portion, and at which at least a portion of said mounting portion is removed when said developer container and said developing frame body are separated from each other;
a sticking step of sticking a seal member for closing the developer supplying opening provided in the developer container separated at said developing frame body separating step;
a developer refilling step of refilling the developer containing part provided in the developer container separated at said developing frame body separating step with the developer;
a developing frame body coupling step of coupling said developer container and the developing frame body separated at said developing frame body separating step together after said sticking step; and
a supporting member attaching step of attaching the supporting member removed at said removing step onto at least one of said developer container and said developing frame body by the use of a coupling member after said developing frame body coupling step.

12. A method according to claim 11, wherein said developing frame body is joined to said developer container in said joint portion by ultrasonic welding, and at said developing frame body separating step, said developer container and said developing frame body are separated from each other by the use of a cutter.

13. A method according to claim 11, wherein said developing frame body is joined to said developer container in said joint portion by ultrasonic welding, and at said developing frame body separating step, said developer container and said developing frame body are separated from each other by the use of a laser.

14. A method according to claim 11, wherein at said supporting member attaching step, said coupling member is mounted with said supporting member and said developing frame body sandwiched thereby.

15. A method according to claim 11, wherein at said supporting member attaching step, said coupling member is mounted with said supporting member and said developer container sandwiched thereby.

16. A method according to claim 14 or 15, wherein said coupling member is constituted by a U-shaped spring material.

17. A method according to claim 16, wherein said coupling member is constituted by a plate spring material.

18. A method according to claim 11, wherein said mounting portion is a boss having a screw hole for attaching said supporting member by a screw, and at said developing frame body separating step, a portion of said boss is removed.

19. A method according to claim 11, wherein said supporting member has driving force transmitting means for transmitting a driving force to said developing member, and at said supporting member removing step, said supporting member is removed from said developing frame body while holding said driving force transmitting means, and at said supporting member attaching step, said supporting member is attached onto said developing frame body while holding said driving force transmitting means.

20. A method according to claim 11, wherein said supporting member has a developing bias contact for contacting with said developing member and supplying a voltage to said developing member, and at said supporting member removing step, said supporting member is removed from said developing frame body while having said developing bias contact, and at said supporting member attaching step, said supporting member is attached onto said developing frame body while holding said developing bias contact.
